(19) United States
(12) Patent Application Publication
(10) Pub. No.: US 2012/0048976 A1
(43) Pub. Date: Mar. 1, 2012

(54) PRESSURE ROLLER

(75) Inventors: Erich John Hofmann, Western Australia (AU); Karl Peter Steiner, Western Australia (AU)

(73) Assignee: HOFMANN ENGINEERING PTY LTD., Bassendean, Western Australia (AU)

(21) Appl. No.: 13/265,499

(22) PCT Filed: Apr. 20, 2010
(86) PCT No.: PCT/AU2010/000448

§ 371 Date: Oct. 20, 2011

(30) Foreign Application Priority Data
Apr. 20, 2009 (AU) 209901687

(51) Int. Cl. B02C 4/30; B23P 15/00; B02C 4/32; B02C 4/02; B02C 4/28

(52) U.S. Cl. 241/230; 241/300; 241/293; 241/294; 241/227; 29/895

(57) ABSTRACT

The present invention provides a pressure roller for use in semi-autogenous comminution of maters. The roller has an outer face (11) accommodating a set of wear resistance inserts (13) in a spaced array over the outer face. The inserts are embedded in the surface of the roller and extend into an outer section of the roller. Each insert is spaced inwardly from or is flush with the outer face of the roller.

### FIELD OF THE INVENTION

This invention relates to high pressure rollers which are to be used in the grinding of materials and in particular high pressure rollers which are utilised in semi-autogenous grinding mills.

### BACKGROUND

The following discussion of the background art is intended to facilitate an understanding of the present invention only. The discussion is not an acknowledgement or admission that any of the material referred to is or was part of the common general knowledge as at the priority date of the application.

It is a characteristic of semi-autogenous grinding mills that a portion of the grinding surface of the roller is made up from rock material which has been previously ground and which is retained on the surface of the roller. In such rollers the surface is provided with wear resistant elements at spaced locations to prevent the excessive wear of the face of the roller.

An example of such rollers is disclosed in Australian patent 655465 (AU-B-16360/92). This patent discloses a roller having a set of wear resistant inserts embedded in its outer face. The inserts are located in a spaced array over the surface of the roller such that they protrude from the face of the roller. During operation the gaps between the protruding inserts fill with the material which has been comminuted by the roller press. The material builds up to form a continuous outer layer around the roller. This provides protection to the outer face of the roller and typically remains in place during the grinding action.

A difficulty that has been encountered with rollers of the forms disclosed in AU655465 is that the protruding portions of the wear resistant inserts break or shatter when subjected to lateral forces. In addition it has been observed that when an insert does break or shatter the protective function that the insert previously provided to the surrounding matrix of the roller is lost. This results in increased wear of the matrix of the roller's surface surrounding the broken insert which can significantly accelerate the degradation of the surface of the roller.

Another form of roller is disclosed in U.S. Pat. No. 4,848,683. In this patent the roller has an outer face which is defined by a set of blocks around the circumference of the roller. The blocks are of alternate wear resistance such that in use the blocks having the least wear resistance will wear at a greater rate to create recesses between the blocks of high wear resistance. If such rollers are utilised in a semi-autogenous mill it is anticipated that the recesses formed in the face of the roller will be filled with comminuted material such that the effect of the rollers would be to effect semi-autogenous grinding.

In the case of semi-autogenous mills utilising rollers of the form disclosed in U.S. Pat. No. 4,848,683 it is envisaged that for the initial period of operation of the roller there will be no or minimal semi-autogenous grinding of the rock material as there is no provision for accommodating particulate material in the face of the roller. That capacity will only arise, once the material of lower wear resistance between the blocks of harder wear resistance has been worn away, and so created the recesses. As a result it is anticipated that during the initial period of operation of the roller there would be considerable “slippage.” between the faces of the rollers which would significantly reduce the efficiency of the roller.

### DISCLOSURE OF THE INVENTION

Throughout the specification and claims, unless the context requires otherwise, the word “comprise” or variations such as “comprises” or “comprising”, will be understood to imply the inclusion of a stated integer or group of integers but not the exclusion of any other integer or group of integers.

Accordingly the invention resides in a pressure roller for use in semi-autogenous comminution of materials, the roller having an outer face accommodating a set of wear resistance inserts which are in a spaced array over the outer face, the inserts being embedded in the surface of the roller and extending into an outer section of the roller whereby an outer end of each insert is spaced inwardly from or is flush with the outer face of the roller.

Accordingly the invention resides in a pressure roller for use in semi-autogenous comminution of materials, the roller having an outer face accommodating a set of wear resistance inserts which are in a spaced array over the outer face, the inserts being embedded in the surface of the roller and extending into an outer section of the roller whereby an outer end of each insert is spaced inwardly from the outer face of the roller.

In contrast to the prior art, the inserts of the present invention are located below the outer face of the roller. In use the inserts will be protected by the roller body, ensuring the inserts are not exposed to lateral forces which would otherwise damage the inserts.

According to a preferred feature of the invention the roller is cylindrical.

According to a preferred feature of the invention each insert is spaced inwardly from the outer face of the roller.

According to a preferred feature of the invention the inserts are made from a material harder than the material of the roller's outer section.

According to a preferred feature of the invention a set of recesses are provided in the outer face of the roller, the recesses being laterally spaced from the adjacent inserts. The recesses, coupled with the indentation caused by the insert being located below the rollers outer face, will help create a layer of particulate material around the roller's outer face. Furthermore, the material around the insert will be protected by the insert which in turn ensures the insert has greater protection from lateral forces than prior art rollers.

According to a preferred feature of the invention a lower face of the recess is below the outer end of the insert.

According to a preferred feature of the invention the lower face of the recess is part spherical.

According to a preferred feature of the invention the recesses are substantially equidistant from adjacent inserts.

According to a preferred feature of the invention the inserts are located at substantially evenly displaced positions over the face of the roller.

According to a preferred feature of the invention the spacing of the inserts over the face of the roller varies. This may be useful in accommodating different wear rates on the outer face of the roller.

The inserts may vary in size or shape relative to each other.

According to a preferred feature of the invention one or more channels may extend between the insert and one or more recesses.

According to a preferred feature of the invention one or more channels may extend between the inserts.

According to a preferred feature of the invention each insert may vary in wear resistance according to its position on the roller. In use, different areas of the roller experience different wear patterns. It may be desirable in those areas which experience more wear to have inserts of increased hardness, different shape and/or different size so that the inserts do not wear as quickly.

According to a preferred feature of the invention the wear resistant properties of the roller may be greater in those areas of the roller which experience higher wear patterns.

According to a preferred feature of the invention the inserts and recesses are spaced to ensure maximum accumulation of particulate material during operation.

According to a preferred feature of the invention each insert may comprise an insert body received in an insert holder, the insert holder being adapted to be received in the respective pocket. The insert body may be cylindrical or may be any given shape.

According to a preferred feature of the invention the roller is formed by one or more plates secured to a cylindrical body, the one or more plates may have the inserts embedded therein and recesses formed therein.

According to a preferred feature of the invention the roller is conical or frusto-conical in shape.

Accordingly the invention resides in a pressure roller which for use in semi-autogenous communition of materials, the roller having a cylindrical outer face accommodating a set of wear resistance inserts which are in a spaced array over the outer face, the inserts being embedded in the surface of the roller whereby an outer end of each insert is spaced inwardly from the outer face of the roller.

Accordingly the invention resides in a pressure grinding roller, the roller comprising:
a cylindrical outer face accommodating a set of wear resistance inserts which are in a spaced array over the outer face, the inserts being embedded in the surface of the roller; and
a set of recesses provided in the outer face of the roller, the recesses being laterally spaced from the adjacent inserts;
   whereby during the grinding process particulate material co-operates with the recesses to form a layer of material around the roller.

According to a preferred feature of the invention an outer end of each insert is spaced inwardly from the outer face of the roller.

According to a preferred feature of the invention an outer end of each insert is flush with the outer face of the roller.

Accordingly the invention resides in a pressure roller for use in semi-autogenous communition of materials, the roller having a cylindrical outer face accommodating a set of wear resistance inserts which are in a spaced array over the outer face, the inserts being embedded in the surface of the roller whereby an outer end of each insert is spaced inwardly from or is flush with the outer face of the roller.

Accordingly the invention resides in a pressure roller for use in semi-autogenous communition of materials, the roller having a cylindrical outer face accommodating a set of wear resistance inserts which are in a spaced array over the outer face, the inserts being embedded in the surface of the roller whereby an outer end of each insert is flush with the outer face of the roller.

Accordingly the invention resides in an ore grinding mill incorporating a pair of rollers each as herein before described, the rollers being supported in parallel spaced apart relationship and driven in contra-rotation so as in use to grind ore fed between the rollers.

According to a preferred feature of the invention, the clearance space between the rollers is adjustable.

According to a preferred feature of the invention, the rotational axes of the rollers are generally horizontal.

According to a preferred feature of the invention, the rollers are generally cylindrical.

Accordingly the invention resides in a method of forming a pressure roller as herein before described, the method including the steps of:
providing a roller body having an'outer section defining an outer face,
forming an array of pockets in the outer section, and
securing a corresponding series of wear resistance inserts in the respective pockets,
such that an outer end each insert is either flush with or spaced inwardly from the outer face of the roller.

According to a preferred feature of the invention, the pockets are formed by drilling, boring or milling, but may alternatively be formed by other methods including laser cutting, high pressure water cutting, casting, forging, electro chemical machining (ECM), electro discharge machining (EDM) etc.

The invention will be more fully understood in the light of the following description of one specific embodiment.

### BRIEF DESCRIPTION OF THE DRAWINGS

The description is made with reference to the accompanying drawings of which:

FIG. 1 is a schematic plan view of a portion of the face of a roller according to an embodiment of the invention;

FIG. 2 is a schematic partial sectional side elevation of the face of the roller according to the embodiment along line 2-2 of FIG. 1;

FIG. 3 is a schematic partial sectional side elevation of the face of the roller according to the embodiment along line 2-2 of FIG. 1 illustrating the anticipated profile of the face after a pre-determined degree of wear in which the matrix of the outer face of the roller has been worn to coincide with the outer end of each insert shown;

FIG. 4 is a schematic partial sectional side elevation of the face of the roller according to the embodiment along line 2-2 of FIG. 1 illustrating the anticipated profile of the face after a pre-determined degree of wear in which the matrix of the outer face of the roller has been worn to a level below the inserts;

FIG. 5 is view of the roller showing part of the roller having pockets and recesses formed therein; and

FIG. 6 is a sectional view (D) of FIG. 5.

### DETAILED DESCRIPTION OF THE SPECIFIC EMBODIMENT

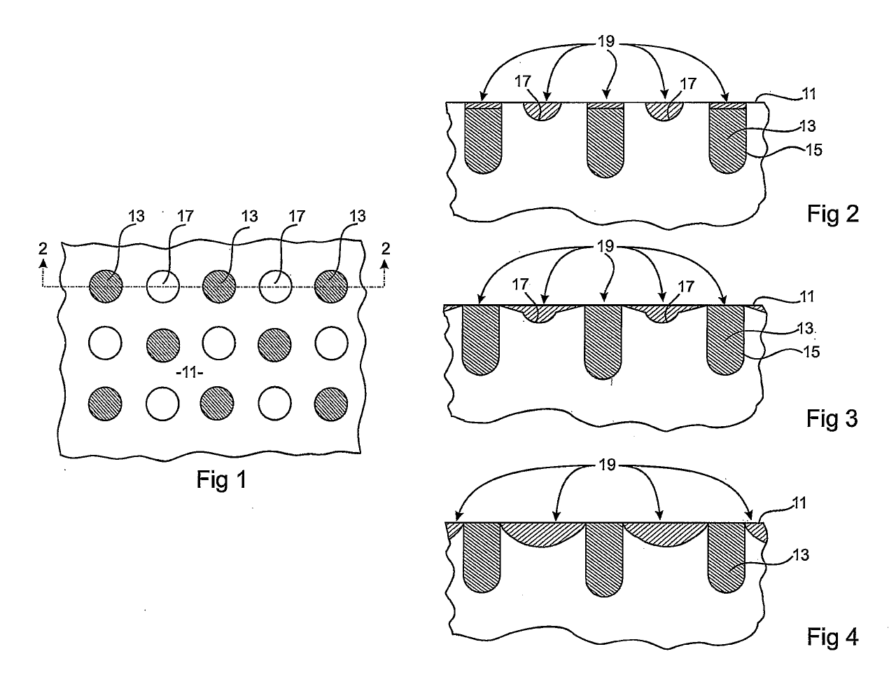

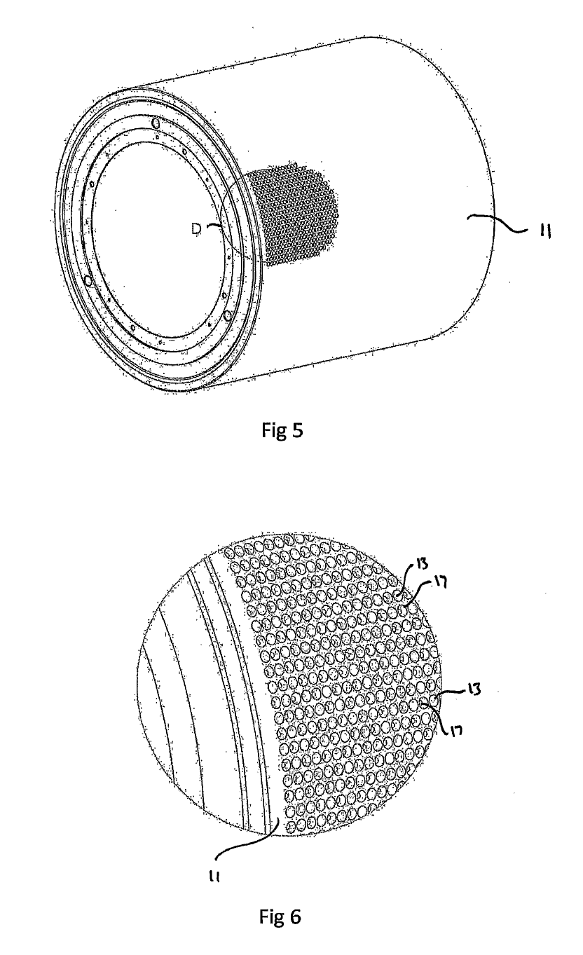

An embodiment of the invention depicted in FIGS. 1 to 6 is directed to a roller which is intended for use in the high pressure, semi-autogenous grinding of material. In such a process it is highly desirable for ground ore material to be present on the outer face of the roller to effect at least part of the grinding action, in addition to providing a degree of protection to the outer face of the roller.

The roller according to the embodiment is provided with an outer cylindrical face 11. The outer face 11 has a number of inserts 13 embedded therein. Each insert 13 is made from a wear resistant material such as carbide and is received in a pocket 15 which is of a complementary configuration to the insert 13. Each pocket 15 is formed in the outer face 11 of the roller, which in this embodiment extend radially into the outer section of the roller. The outer section may undergo a hardening process.

Each insert 13 is typically fixed in position by gluing, but may also be fixed by welding, being screwed or keyed into position, be formed to have an interference fit relative to the pocket or any appropriate means. The inner end face of the inserts has a hemispherical end face.

Each pocket 15 has a depth greater than the length of the insert 13 in order that upon insertion of the insert 13 into the pocket 15 the outer end of the insert 13 is located inward of the outer face 11 of the roller. This then forms an indentation in the outer face of the roller.

In addition the outer face of the roller is provided with a set of recesses 17 which are part spherical in configuration and have a depth less than the pockets 15. The recesses 17 are located intermediate the pockets 15 and are equi-distant from adjacent pockets 15.

Upon initial use of the roller a layer 19 of semi-autogenous comminuted material created by the grinding process will become deposited in the pockets defined between the indentations created by each of the inserts 13 and the outer face 11 of the roller. Furthermore, upon the initial use of the roller the layer 19 of semi-autogenous comminuted material created by the grinding process will also become deposited in the recesses 17. The resultant semi-autogenous layer 19 will then enable the roller to effect the semi-autogenous grinding of further rock material which passes between a pair of grinding rollers. In addition the presence of the semi-autogenous layer 19 in the outer ends of the pockets and in the recesses will facilitate traction between the rollers while effecting the desired grinding action.

As a result of further use of the roller, the matrix defining the outer face 11 of the roller between the inserts will become worn. FIG. 3 illustrates the anticipated profile of the outer face of the roller after the matrix surrounding the inserts has been worn to the level of the outer ends of the inserts. However, the wear of the outer face outward of the portion of the matrix surrounding the inserts will be greater and will be at its maximum in the region of the recesses 17. This will cause the outer face of the roller to adopt a scalloped or convoluted profile which will serve to retain the semi-autogenous layer 19 generated by the grinding action of the roller and to provide the requisite outer face of the roller for the semi-autogenous grinding of further material.

With further wear of the outer face of the roller as shown at FIG. 4 the presence of the inserts 13 will serve to preferentially protect the matrix of the outer face of the roller in the regions immediately surrounding the inserts compared to the portions located intermediate of the inserts 13 to maintain the scalloped or convoluted profile in the outer face of the roller and to accommodate the semi-autogenous layer 19 resulting from the grinding action. However as the sides of the inserts will be bordered by the surrounding matrix the sides of the inserts will be protected from laterally directed forces and so the surrounding matrix will serve to protect the inserts against breakage or shattering.

A roller according to the embodiment will have a significantly greater life than that which is the subject of AU655465 by virtue of the fact that the inserts do not extend beyond the face of the roller. Furthermore, throughout their working life the inserts are supported at their sides by the matrix material closely bordering the inserts, serving to protect the inserts from shattering or breakage. In addition, from the beginning of its operation the roller will be effective in providing semi-autogenous grinding of rock material as the indentations provided at the outer ends of the pockets 15 and the recesses 17 will facilitate the formation of the semi-autogenous layer 19 on the outer face of the roller. This is also in contrast to the roller which is the subject of U.S. Pat. No. 4,848,683 which requires the roller to have been subjected to some wear before any form of recess is formed in the outer face of the roller.

Whilst in the present embodiment the pocket extends radially into the roller, it is to be understood that the pockets may extend inwardly at any angle. It is also to be understood that the angle of each pocket may vary according to its position on the roller. Furthermore, the pockets may be formed on all surfaces, part of a surface and/or only on one surface of the roller.

The pockets may be formed in the roller by any known means including drilling, milling, boring, laser or water cutting, casting, electro chemical machining (ECM), electro discharge machining (EDM) or chemical means.

Similarly the recesses may also be formed in the roller by any known means including drilling, milling, boring, laser or water cut, casting, electro chemical machining (ECM), electro discharge machining (EDM). Whilst the embodiments illustrate a roller in which the recesses are part spherical in configuration, it would be understood by the person skilled in the art that the recesses may take any shape, such as, for example, a cylindrical shape with a flat base, with such variations still falling within the scope of this specification.

The material which may be comminuted by the pressure roller includes rock, ore, recyclable materials.

The present invention is not to be limited in scope by the specific embodiment described herein. The embodiment is intended for the purpose of exemplification only. Functionally equivalent products, elements and methods are clearly within the scope of the invention as described herein.

1. A pressure roller for use in the semi-autogenous comminution of materials, the roller having an outer face accommodating a set of wear resistance inserts which are in a spaced array over the outer face, each insert being embedded in the surface of the roller and extending into an outer section of the roller whereby an outer end of each insert is spaced inwardly from the outer face of the roller.

2. The pressure roller according to claim 1 wherein the roller is cylindrical.

3. The pressure roller according to claim 1, wherein the inserts are made from a material harder than the material of the roller's outer section.

4. The pressure roller according to claim 1, wherein recesses are provided in the outer face of the roller, the recesses being laterally spaced from adjacent inserts.

5. The pressure roller according to claim 4 wherein a lower face of the recess extends below the outer end of the insert.

6. The pressure roller according to claim 4, wherein the recesses are substantially equidistant from the adjacent inserts.

7. The pressure roller according to claim 1, wherein the inserts are located at substantially evenly displaced positions over the face of the roller.

8. The pressure roller according to claim 1, wherein the spacing of the inserts over the face of the roller varies.

9. The pressure roller according to claim 1, wherein the inserts vary in size and/or shape relative to each other.

10. The pressure roller according to claim 4, wherein one or more channels extend between the insert and one or more recesses.

11. The pressure roller according to claim 8 wherein one or more channels extend between the inserts.

12. The pressure roller according to claim 1, wherein each insert varies in wear resistance properties according to its position on the roller.

13. The pressure roller according to claim 1, wherein the wear resistant properties of the roller may be greater in those areas of the roller which experience higher wear patterns.

14. The pressure roller according to claim 4, wherein the inserts and recesses are spaced to ensure maximum accumulation of particulate material during operation.

15. The pressure roller according to claim 1, the insert comprising an insert body received in an insert holder, the insert holder being adapted to be embedded in the roller.

16. The pressure roller according to claim 1, wherein the roller is formed by one or more plates secured to a cylindrical body, the one or more plates may have the inserts embedded therein and recesses formed therein.

17. The pressure roller according to claim 1, wherein the roller is conical or frusto-conical in shape.

18. A pressure roller for use in the semi-autogenous comminution of materials, the roller having a cylindrical outer face accommodating a set of wear resistance inserts which are in a spaced array over the outer face, the inserts being embedded in the surface of the roller whereby an outer end of each insert is spaced inwardly from the outer face of the roller.

19. A pressure grinding roller, the roller comprising:
a cylindrical outer face accommodating a set of wear resistance inserts which are in a spaced array over the outer face, the inserts being embedded in the surface of the roller; and
a set of recesses provided in the outer face of the roller, the recesses being laterally spaced from the adjacent inserts;
whereby during the grinding process particulate material co-operates with the recesses to form a layer of material around the roller.

20. The pressure roller according to claim 19, wherein an outer end of each insert is spaced inwardly from the outer face of the roller.

21. The pressure roller according to claim 19, wherein an outer end of each insert is flush with the outer face of the roller.

22. (canceled)

23. An ore grinding mill incorporating a pair of rollers each according to claim 1, the rollers being supported in parallel spaced apart relationship and driven in contra-rotation so as in use to grind ore fed between the rollers.

24. The ore grinding mill according to claim 23, wherein the clearance space between the rollers is adjustable.

25. The ore grinding mill according to claim 23, wherein the rotational axes of the rollers are generally horizontal.

26. The ore grinding mill according to claim 23, wherein the rollers are generally cylindrical.

27. A method of forming a pressure roller according to claim 1, the method including the steps of:
providing a roller body having an outer section defining an outer face,
forming an array of pockets in the outer section, and
securing a corresponding series of wear resistance inserts in the respective pockets,
such that an outer end of each insert is spaced inwardly from the outer face of the roller.

28. The method of forming a pressure roller according to claim 27, wherein the pockets are formed by drilling, boring or milling, but may alternatively be formed by other methods including laser cutting, high pressure water cutting, casting, forging, etc.
